(19) United States
(12) Patent Application Publication
(10) Pub. No.: US 2013/0062812 A9
(43) Pub. Date: Mar. 14, 2013

(54) PRESS FOR PRODUCING A TAMPON

(71) Applicant: Heinz Graber, Bergdietikon (CH)

(72) Inventor: Heinz Graber, Bergdietikon (CH)

(73) Assignee: RUGGLI PROJECTS AG, Hagendorn (CH)

(21) Appl. No.: 13/391,862

(22) PCT Filed: Aug. 24, 2010
(86) PCT No.: PCT/EP10/05177

§ 371 Date: Apr. 5, 2012

(30) Foreign Application Priority Data
Aug. 24, 2009 (AT) A 1331/2009

(51) Int. Cl. B29C 43/02

(52) U.S. Cl. 264/320; 425/117

(57) ABSTRACT

The invention relates to a method and a press (1) for producing a tampon preform (2′) by radially pressing a tampon blank (2) made of an absorbent material by means of compression jaws (3) which are arranged around a pressing region, characterized in that the press (1) comprises guide blades (4, 4′, 4″) for centering the tampon blank (2) in the radial and/or axial direction in the pressing region.

The invention relates to a press for producing a tampon by radially pressing a tampon blank made of an absorbing material by means of compression jaws, which are arranged around a pressing region.

The invention furthermore relates to a method for producing a tampon by radially pressing a tampon blank made of an absorbent material by means of compression jaws, which are arranged around the pressing region of a press.

Tampons are widely known sanitary products that can be produced of strips of absorbent cotton that are rolled and subsequently compressed in a press apparatus, due to the manufacturing process typically resulting in a circular cylindrical basic shape of the tampon. From prior art, many different tampons have been known for a long time, the surface properties of which are changed physically and/or chemically to create esthetic as well as functional advantages. In this connection, press apparatuses for producing tampons providing heterogeneous surface topography—especially in the form of longitudinal grooves, having different depths if applicable, in the surface of the tampon—have been known. Such a press of the manner mentioned at the beginning has been known from the EP 0639 363 for example. The known press has a pressing region with compression jaws that are moveable radially to a tampon and that each comprise a penetration segment for penetrating into the absorbent material. The disadvantage of the known presses is that the tampon is usually inserted into the pressing region in a relatively uncontrolled manner, what can result in a not correct positioning of the tampon in the pressing region. Different positionings of tampons along the axis of the pressing regions result in an appearing of patterns embossed into the surface at different places of the tampon. A homogeneous appearing of tampons produced with the press is thus not ensured with the conventional presses. A displacement of the tampon blank in radial direction can result in an inhomogeneous compression, what may have a negative effect on the quality of the finished tampon.

It is thus the objective of the invention to overcome the above mentioned disadvantages.

Using a press in the manner mentioned at the beginning, this objective is according to the present invention provided by a press comprising guide blades for centering the tampon blank in radial and/or axial direction in the pressing region.

By using guide blades, an exact positioning of a tampon in the pressing region and thus an essential enhancement of the quality of a pressed tampon can be achieved.

A particularly good guiding of the tampon blank can be achieved by arranging the guide blades radially around the pressing region, viewed in the direction of the latter.

A particularly advantageous embodiment of the invention is that each guide blade is arranged between two adjacent compression jaws. Thus, a very space-saving arrangement can be realized that is additionally characterized by being able to avoid restrictions concerning movements of the compression jaws. With the embodiment just having been mentioned it is of particular advantage if the guide blades are mounted in the press in a fixed manner. Due to the fixed mounting of the guide blades, the compression jaws can be moved towards each other during the pressing of the tampon blank and the guide blades do not move in line with these movements and obstruct the actual pressing process.

An exact positioning of the tampon in axial direction can be achieved by arranging and/or embodying the guide blades in a converging way in the direction of the insertion of the tampon into the pressing region.

According to an advantageous variant of the invention, which is characterized by a particularly simple composition, the guide blades can be mounted in the press in a fixed manner.

In order to ensure a good guidance of the tampon into the pressing region during the insertion process, at least three guide blades can be provided.

In order to ease the insertion of the tampon blank between the guide blades, the guide blades can be spaced more widely from one another in a collecting region provided for the collecting of the tampon blank than in a section further away from the collecting region.

Another possibility to achieve an exact positioning of the tampon blank in axial direction in the pressing region is, that at least one guide blade has a stopper for the tampon blank at its end facing towards the pressing region.

A good guiding performance for positioning the tampon blank can be achieved by embodying the guide blades spring-elastic.

Generally speaking, the guide blades can be embodied plate-shaped and one respective edge of the plate-shaped guide blades projecting into the interior of the pressing region is provided for the guidance of the tampon blank.

According to an embodiment of the invention that is characterized by a particular favorable composition, which also ensures that there is no impediment of the compression jaws during the pressing process, at least segments of the guide blades can be arranged at an annular mounting element and held in their position by it. Alternatively, the guide blades can be arranged at an outlet nozzle of the press.

The above mentioned objective can also be achieved by a method of the manner according to the invention mentioned at the beginning that the tampon blank is centered in radial and/or axial direction by means of guide blades during the insertion into the pressing region.

The invention providing further advantages will be explained in more detail below by means of a non-restricting exemplary embodiment shown in the drawings. These schematically show:

FIG. 1 a plan view on a pressing region of a press according to the invention;

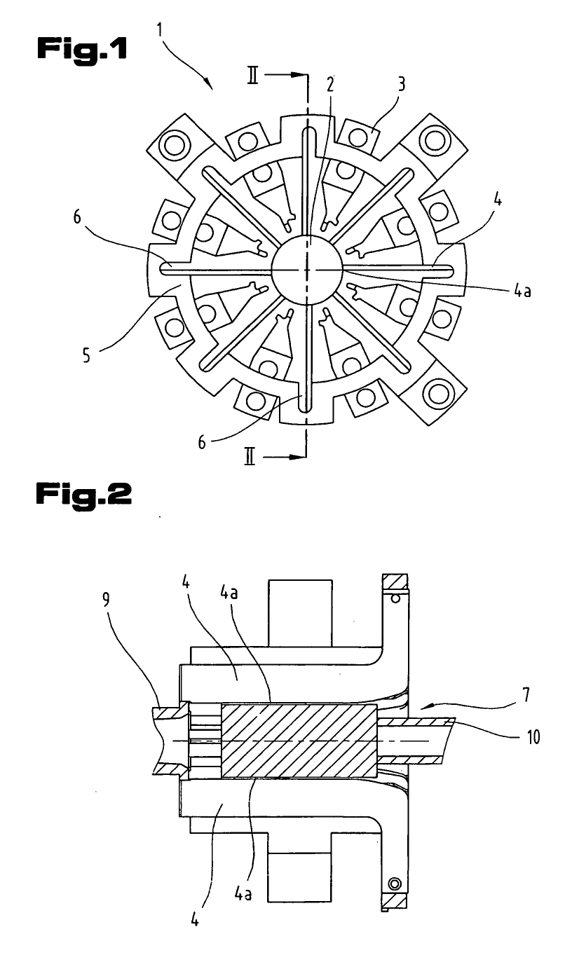

FIG. 2 a cut along the line II-II in FIG. 1 of a first variant of the embodiment;

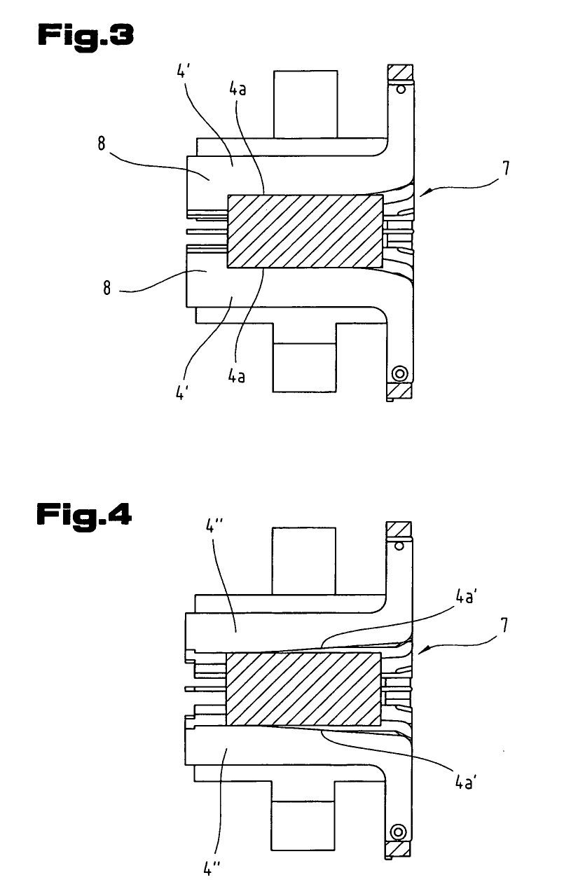

FIG. 3 a cut along the line II-II in FIG. 1 of a second variant of the embodiment;

FIG. 4 a cut along the line II-II in FIG. 1 of a third variant of the embodiment;

FIG. 5 a side-view of a variant of the invention, where the guide blades are arranged at an outlet nozzle of the press;

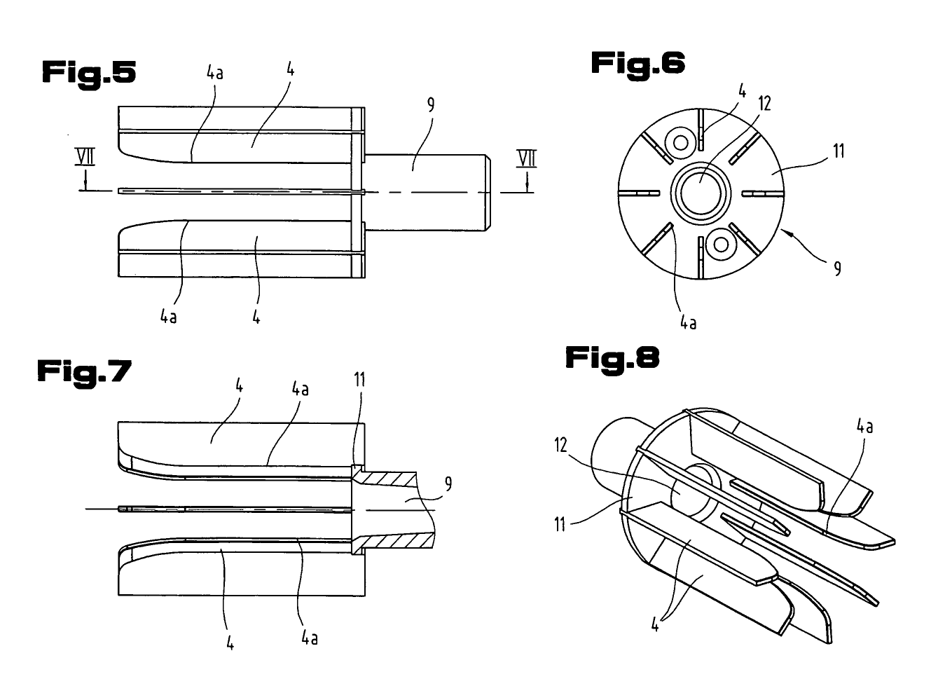

FIG. 6 a plan view on the a variant of FIG. 5;

FIG. 7 a cut along the line VII-VII in FIG. 5;

FIG. 8 a perspective view of the variant of FIG. 5;

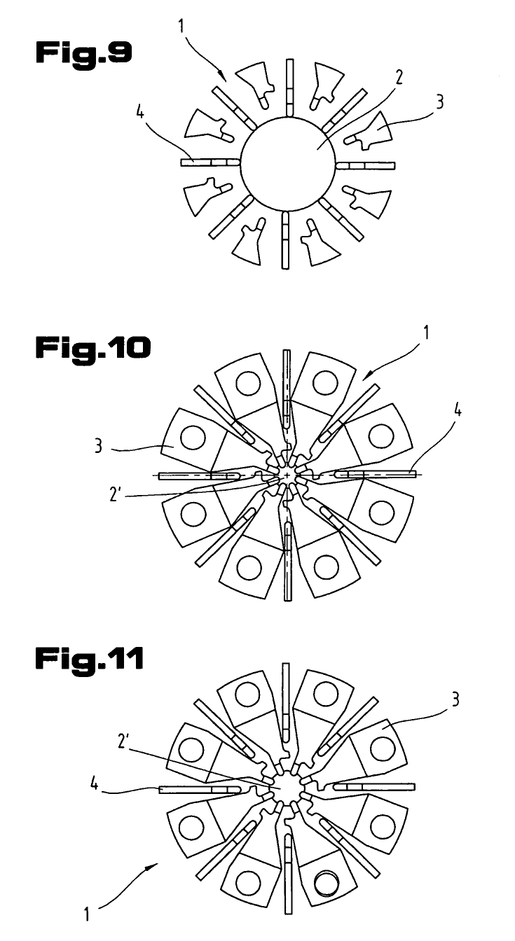

FIG. 9 the pressing region of FIG. 5 with open compression jaws;

FIG. 10 the pressing region of FIG. 1 with closed compression jaws moved towards one another during the pressing process and

FIG. 11 the pressing region of FIG. 1 during a drawing process for removing the pressed tampon preform.

First of all, it should be pointed out that in the variously described exemplary embodiments the same parts are given the same reference numerals and the same component names, whereby the disclosures contained throughout the entire description can be applied to the same parts with the same reference numerals and the same component names. Also details relating to position used in the description, such as e. g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions or solutions according to the invention.

According to FIG. 1, a press 1 according to the invention comprises compression jaws 3 radially arranged around a pressing region for compressing a tampon blank 2. The tampon blank 2 can be formed by for example rolling or folding a piece of mat of an absorbent material, for example absorbent cotton. This tampon blank 2 is afterwards inserted into a pressing region of the press 1 situated between the compression jaws 3 and radially compressed by means of the compression jaws 3.

In order to allow a axial and/or radial centering of the tampon blank 2 to be compressed in the press 1, guide blades 4 are provided, which guide the tampon blank 2 exactly to a defined position within the pressing region between the compression jaws 3.

In this case, the term “axial” refers to the longitudinal axis of the pressing region of the press situated between the compression jaws 3. The term “radial” refers to a direction extending normally to the longitudinal axis of the pressing region.

The radial centering of the tampon blank 2 in the pressing region has the result that the longitudinal axis of the pressing region essentially falls close to the longitudinal axis of the tampon blank 2, whereas the axial centering regards the positioning of the tampon blank 2 along the longitudinal axis of the pressing region.

As it can be seen in FIG. 1, each guide blade 4 is arranged between two adjacent compression jaws 3. The guide blades can in this case be essentially fixed of immovable.

The guide blades 4 can be embodied plate-shaped, and one respective edge 4a of the plate-shaped guide blades 4 facing the interior of the press 1 is provided for the guidance of the tampon blank. In this case, the term “plate-shaped” generally refers to a body with flat face surfaces and the thickness of which is considerably smaller than its length and width. Generally, guide blades 4 can also be embodied different from plate-shaped, nevertheless, a plate-shaped embodiment is especially suitable due to its simple shape and mounting. Additionally, the guide blades 4 can be embodied springy as well as inflexible. The edges 4a of the guide blades 4 do not have to be flat or straight but can also be embodied for example curved or undulated. Generally, the edges 4 can have any other suitable shape.

Additionally, the guide blades 4 can be fixed to a mounting ring 5 with one section each, as it can be seen in FIG. 1. Viewed in the direction of the insertion movement of the tampon blank 2, the compression jaws 3 can be arranged behind the mounting ring 5 with the result that the mounting ring 5 does not cause any impediments of the movements of the compression jaws 3. The mounting ring 5 itself can be fixed to the press 1 by appropriate fastening means, for example by means of a screw connection. Of course, any other way of fastening is possible as well, for example welding, gluing, locking etc.

As shown in FIG. 1, the mounting ring 5 can have collectors 6 for the guide blades 4. The guide blades 4 can be fixed to the mounting ring 5 by gluing, welding, soldering, clamping, screwing etc. The kind of connection of the guide blades 4 with the mounting ring 5 does also depend on the kind of the materials used. Thus, the mounting ring 5 or the guide blades 4 can be for example embodied of metal or plastics. In principle, it would also be possible to design the guide blades 4 and the mounting ring 5 integrally.

For fastening the guide blades 4, it is not necessary to provide a mounting ring 5. The guide blades 4 can also, as shown in more detail in FIGS. 5 to 8, be fixed to an outlet nozzle of the press 1, which is used to deliver the tampon blank 2 compressed to be a tampon preform 2′ by means of the compression jaws 3 out of the press 1. In the FIGS. 2 to 5, the outlet nozzle has been given the reference numeral 9. By means of the guide blades 4, the tampon blank 2 is such decelerated during the insertion, that it is ground to halt and exactly positioned at the place intended. Also in case of high speeds, the solution according to the invention allows to such decelerate the tampon blank 2 that it is stopped at exactly the position intended within the press 1. In particular, the solution according to the invention can avoid resilience due to the mass inertia of the tampon blank 2 from a rear panel bordering the pressing region or the from the outlet nozzle 9 of the press 1.

As additionally can be seen in FIG. 1, the guide blades 4 can be arranged radially around the pressing region. Instead of the eight guide blades 4 shown, any other number of guide blades 4 can be provided. Advantageously, at least three guide blades 4 are used in order to ensure a sufficiently good guidance of the tampon blank 2.

As it can be seen in FIG. 2, the guide blades 4 in a collecting region 7 for collecting the tampon blank 2 can be spaced more widely from one another than in a section situated further in the pressing region. The slightly larger distance between the guide blades 4 in the collecting region 7 for the tampon blank 2 ensures that the tampon blade 2 can be easily inserted into the space between the guide blades 4. As it can furthermore be seen, the guide blades 4 in the collecting region 7 can be curved projecting away from one another in order to enlarge the entrance area and thus to ease the insertion of the tampon blank 2.

The tampon blank 2 can, as shown in FIG. 2, be inserted into the pressing region by means of a punch- or tube-shaped inserter 10. Instead of the inserter 10, the tampon blank 2 can also be blown into the pressing region by means of a not shown nozzle and by using compressed air.

Generally, the tampon blank 2 can also be inserted into the pressing region by any other way, for example the guide blades 4 can be used as means of conveyance for the tampon blank 2. In this case, the guide blades 4 could perform a feeding movement into the direction of the pressing region in order to transport the tampon blank 2 to its pressing position situated in the pressing region. It would also be possible that the guide blades 4 comprise means of conveyance, for example a belt running around the guide blades 4 that grabs the tampon blank 2 along the edges 4a and transports it into the pressing region like a band-conveyor.

Another variant of the solution according to the invention would be that the guide blades 4 form a cage that can be took out of and inserted into the pressing region and collects the tampon blank 2. The cage formed by the guide blades 4 can completely be inserted into the press 1 after having collected the tampon blank 2. Thus, the guide blades 4 and the tampon blank 2 can be inserted into the press together or at the same time, with the insertion of the tampon blank 2 between the guide blades 4 being possible to take place outside the press 1.

Concerning all forms of embodiment of the invention, the guide blades 4 are nevertheless advantageously such arranged that they are arranged fixed in the press 1 and do not restrict the movements of the compression jaws 3 during the pressing process which compresses the tampon blank 2 to be a tampon preform 2′.

In a section situated within the pressing region, the guide blades 4 can for example run parallel to one another, with the distance of the guide blades 4 being such chosen, that sections of the guide blades 4 bear against the surface of the tampon blank 2. Nevertheless, the distance of the guide blades 4 can also such be chosen that sections of the guide blades 4 impress into the surface of the tampon blank 2. By the measures mentioned in this paragraph, a good centering of the tampon blank 2 in the pressing region can be achieved.

According to a variant of embodiment it can also be provided that the distance between the guide blades 4 can be adjusted. This can for example be achieved by fixing the guide blades 4 to different places of the collectors 6 of the mounting ring 5, with the result that one guide blade 4 can be arranged closer to or further away from the center of the pressing region if necessary.

According to another form of embodiment of the invention, the distance between the guide blades 4 can also be changed during the operation. This can for example be realized by arranging the guide blades 4 in the collectors 6 to be moveable in radial direction.

As shown in FIG. 3, sections of the guide blades 4′ can essentially run parallel to one another. This means that sections of the edges 4a essentially run parallel to one another. In this case, the guide blades 4′ can have a stopper 8 to limit the movement of the tampon blank 2 in radial direction in the pressing region and thus to enable an exact definition of the situation of the tampon blank 2 in axial direction.

In this case, the stopper 8 can be formed of protrusions of individual guide blades 4′ projecting into the interior of the pressing region. It is not absolutely necessary that all guide blades 4′ have protrusions for forming the stopper 8. It can also be sufficient if the stopper 8 is formed of the protrusion of only one guide blade 4′.

According to the variant of the invention shown in FIG. 4, at their edge 4a′ provided for guiding the tampon blank 2, the guide blades 4″ can be such embodied that the distance between the edges 4a′of the guide blades 4″ decreases with increasing distance from the collector region. The edges 4a′ of the guide blades 4a′ can in this case run conically tapered. In a back region of the guide blades 4″ in the direction of movement of the tampon blank 2, a clamping of the tampon blank 2 avoiding a further movement in axial direction is thus effected. In this way, an exact position of the tampon blank 2 in both axial and radial direction is possible.

According to FIG. 5, the guide blades 4, as already mentioned, can be arranged at the outlet nozzle 9. As it can furthermore be seen in FIGS. 6 to 8, the guide blades 4 can be arranged at a ring 11 extending around an opening 12 of the outlet nozzle 9. In this case, the guide blades 4 can be designed integrally with the outlet nozzle 9 or can be connected to the latter. The guide blades can thus be glued, welded, soldered or screwed to the outlet nozzle 9 or they can be connected to the outlet nozzle 9 in any other way. Both the outlet nozzle 9 and the guide blades 4 can in this case be made of plastics or metal. Also regarding the embodiment shown in the FIGS. 5 to 8, the guiding blades 4 are mounted in the press in a fixed manner.

As it can be seen in FIG. 9, the compression jaws 3 are open during the insertion of the tampon blank 2 into the press 1 and only the guide blades 4 bear against the tampon blank 2 during this process. After the tampon blank 2 is positioned in the pressing region, the compression jaws 3 are moved towards the tampon blank 2.

In FIG. 10 can be seen that during the pressing, the compression jaws 3 move in radial direction towards the tampon blank 2 and compress the latter, whereas the fixed guide blades 4 remain at their original position and lose contact to the tampon blank 2′ during the pressing process. Due to the fixed arrangement of the guide blades 4, it can be avoided that the movement of the compression jaws 3 is obstructed by the guide blades 4 during the pressing process.

FIG. 11 shows the press in a position when the tampon preform 2′ produced by pressing or compressing of the tampon blank 2 is ejected out of the press 1. In this case, the compression jaws 3 are slightly returned from the tampon preform 2′. According to the preferred embodiment, the guide blades 4 do not bear against the tampon preform 2′, as it can be seen in the drawing.

At this point it should be noted for the sake of completeness that, although the compression jaws 3 shown have penetration segments for embossing grooves, also compression jaws of any other shape not having such penetration segments can be used to realize the invention and the invention is not restricted to the compression jaws 3 shown.

Concluding it should be stated that the above described exemplary embodiments refer to possible variants of embodiment of the solution according to the invention and are not intended to limit the scope of the invention to these illustrated variants of embodiments provided herein but that there are also various combinations among the variants of the embodiments themselves and variations regarding the present invention should be executed by a person skilled in the art. All and every imaginable variants of the embodiment, arising from combining single details of the variant of embodiment illustrated and described are subject to scope of protection. The protection also applies to the individual components of the device according to the invention, as far as they are themselves essential for realizing the invention.

### LIST OF REFERENCE NUMERALS

1 Press
2 Tampon blank
2′ Tampon preform
3 Compression jaws
4 Guide blades
4a, 4a′ Edges of the guide blades
5 Mounting ring
6 Retainers
7 Retaining region
8 Stopper
9 Output nozzle
10 Inserter
11 Ring of the output nozzle
12 Opening of the output nozzle

1. Press (1) for producing a tampon preform (2′) or a tampon by radially pressing a tampon blank (2) made of an absorbent material by means of compression jaws (3), which are arranged around a pressing region, wherein the press (1) comprises guide blades (4, 4′, 4″) for centering the tampon blank (2) in radial and/or axial direction in the pressing region.

2. Press according to claim 1, wherein the guide blades (4, 4′, 4″) are arranged radially around the pressing region.

3. Press according to claim 2, wherein each guide blade (4, 4′, 4″) is arranged between two adjacent compression jaws (3).

4. Press according to claim 1, wherein the guide blades (4″) are arranged and/or embodied in a converging in direction of insertion of the tampon blank (2) into the pressing region.

5. Press according to claim 1, wherein the guide blades (4, 4′, 4″) are mounted in the press (1) in a fixed manner.

6. Press according to claim 1, wherein at least three guide blades (4, 4′, 4″) are provided.

7. Press according to claim 1, wherein the guide blades (4, 4′, 4″) in the collector region (7) provided for collecting the tampon blank (2) are spaced more widely from one another than in a section further away from the collecting region (7).

8. Press according to claim 1, wherein at least one guide blade (4′) comprises a stopper for the tampon blank (2) at its ending situated in the pressing region.

9. Press according to claim 1, wherein the guide blades (4, 4′, 4″) are embodied springy.

10. Press according to claim 1, aha wherein the guide blades (4, 4′, 4″) are embodied plate-shaped with one respective edge (4a, 4a′) of the plate-shaped guide blades (4, 4′, 4″) facing the interior of the pressing region being provided for the guidance of the tampon blank (2).

11. Press according to claim 1, wherein the guide blades (4, 4′, 4″) are arranged at an annular mounting element (5) and held in their position by it.

12. Press according to claim 1, wherein the guide blades (4, 4′, 4′) are arranged at an outlet nozzle (9) of the press.

13. Method for producing a tampon preform (2′) by radially pressing a tampon blank (2) made of an absorbent material by means of compression jaws (3), which are arranged around the pressing region of a press (1), wherein the tampon blank (2), during the insertion into the pressing region, is centered in radial and/or axial direction in the pressing section by means of guide blades (4).
